(19) United States
(12) Patent Application Publication
(10) Pub. No.: US 2005/0081106 A1
(43) Pub. Date: Apr. 14, 2005

(54) Software testing

(76) Inventors: Henry Chang, San Jose, CA (US); Michael A. Di Loreto, Tres Pinos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/681,556

(22) Filed: Oct. 8, 2003

(51) Int. Cl. G06F 11/00

(52) U.S. Cl. 714/38; 717/124

(57) ABSTRACT

A method for testing object-oriented system software having system classes includes examining an application software program including calls to system classes with both a static analysis tool and a dynamic analysis tool. Then both a static use count and a dynamic use count of the system classes are determined. A proportional weighing attribute is assigned to each system class based on its corresponding static use count and dynamic use count. The system classes are then tested in an order determined by the corresponding proportional weighing attributes.

### FIELD OF THE INVENTION

The present invention relates to testing computer software systems in general, and specifically to the automated testing of classes and parts of applications according to weights assigned in relation to how frequently each constituent is called dynamically in operation and its static inclusion.

### BACKGROUND OF THE INVENTION

Many commercial software applications are becoming large and difficult to quickly test thoroughly. It is also true that a handful of functions, or object-oriented classes, are used more than others. In particular applications, it makes sense to exhaustively test those classes that are called the most, and to test as the opportunities arise those classes that get called rarely. Some applications may never call particular classes, and so testing these can be postponed without much adverse consequence.

The ability to test large software applications can be used to commercial advantage by enabling a company to be first-to-market. It would also enable a company to respond with changes to the software quicker and with higher confidence.

### SUMMARY OF THE INVENTION

Briefly, a method embodiment of the present invention for testing object-oriented system software having system classes includes examining an application software program including calls to system classes with both a static analysis tool and a dynamic analysis tool. Then both a static use count and a dynamic use count of the system classes are determined. A proportional weighing attribute is assigned to each system class based on its corresponding static use count and dynamic use count. The system classes are then tested in an order determined by the corresponding proportional weighing attributes.

These and other objects and advantages of the present invention will no doubt become obvious to those of ordinary skill in the art after having read the following detailed description of the preferred embodiment as illustrated in the drawing figures.

### BRIEF DESCRIPTION OF THE DRAWINGS

FIG. 1 illustrates an application software program using system classes; and

FIG. 2 is flowchart of a method embodiment of the present invention.

### DETAILED DESCRIPTION OF EMBODIMENTS OF THE INVENTION

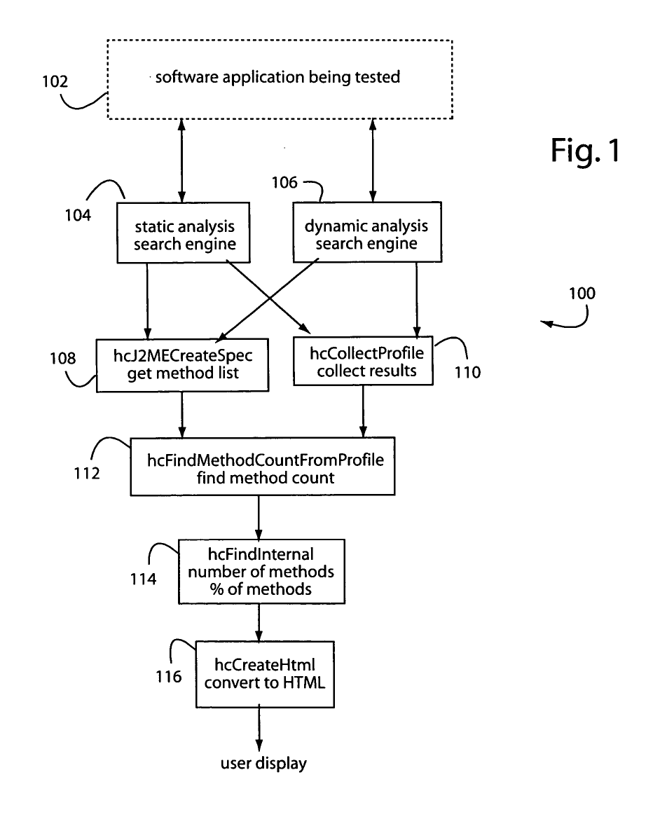

FIG. 1 represents a software testing system embodiment of the present invention, and is referred to herein by the general reference numeral 100. The system 100 tests a software application 102. The system 100 includes a static analysis search engine 104 and a dynamic analysis search engine 106. Such static analysis search engine 104 can be implemented with a method reference counter in C-program for reading Java byte code, e.g., “read_class” by one of the present inventors, Michael Di Loreto. The dynamic analysis search engine 106 can be implemented with Rational PURECOVERAGE for Windows by IBM, or the Java Tool that comes with JDK.

The read_class file format is documented in the Java Virtual Machine Specification, published by Addison Wesley. The output format is unique to the read_class program. Its purpose is to print the contents of a class file. Class files are in binary code, and not human readable without a program specifically designed to print them. There are commercial programs that print class files, e.g., “javap” from Sun Microsystems. But the read_class program cannot be simply replaced by javap because the output formats are different.

TABLE I
The read_class program.

Get class name from the command line.
Read class file into memory.
Check class for correct magic number and version.
Extract the constant pool from the class data.
Print the class header.
Extract and print the fields table.
Extract and print the methods table.
Extract and print the class attributes.
Print the constant pool.
End.

TABLE II
Get class name from the command line.

The only command line argument is the name of the class to
print. It can either be just the class name or the class
file name, that is, it can either have .class at the end
of the name or not. The class file is expected to be in
the current working directory.

TABLE III
Read class file into memory.

Call the read_class giving it the class name. The
read_class calls the new_top_level function giving it the
class name. The purpose of the new_top_level function is
to create a Top Level Table. It begins by calling the
read_classfile function giving it the class name. The
read_classfile function appends “.class” to the class name
to make a file name. Then, it determines the size of the
class file, allocates a memory buffer of that size, reads
the entire contents of the class file into memory, and
returns the pointer to the buffer. The new_top_level
function calls the following functions to extract and
print the class file data.

TABLE IV
Check class for correct magic number and version.

The first four bytes of every valid class file contain the
hexadecimal code “CAFEBABE”. The check_class verifies
that the first four bytes of the class file data contain
this magic number. The next four bytes of every valid
class file contain the major and minor version numbers of
the class file format. Those numbers are 45, 3. The
check_class also verifies that the class file version is
correct.

TABLE V
Extract the constant pool from the class data.

The next thing in the class file, after the magic number
and version, is the constant pool. The new_top_level
functions calls the constant_pool_size function to
determine the number of bytes in the constant pool. The
constant pool begins with a 16-bit count of the number of
entries —1. Following that are the constant pool
entries. Each entry begins with a 1-byte tag which
identifies the type of entry. There are 11 different
constant pool entry tags. Following each tag is the data
for that entry. Most entries are fixed size, so the size
is known from the tag. For example, the CONSTANT_Integer
entry is always four bytes long. One type of entry,
CONSTANT_Utf8, is variable sized. It has a 16-bit length
followed by that number of bytes. The constant_pool_size
function loops through the constant pool, increasing a
pointer for each tag and data. At the end of the loop,
the difference between the pointer and the beginning of
the constant pool is the size of the constant pool. After
the constant_pool_size function returns the size to the
top_level_table function, top_level_table calls the
new_constant_pool function to extract the constant pool
data and create a new internal structure with that data.
There are several reasons for doing this. The main reason
is to convert the data to the right byte order and
alignment for the machine the program is running on.
Binary data in class files is not aligned, and is in
network order, i.e., big-endian. The other reason is to
create a regular structure that can be accessed more
quickly.

TABLE VI
Print the class header.

The new_top_level function prints the access flags, the
class name, and the name of the superclass. Then, if
there are any interfaces, it prints the interfaces count
followed by the number and name of each interface.

TABLE VII
Extract and print the fields table.

The new_top_level function calls the new_fields_table
function. The new_fields_table function prints the fields
count followed by a line for each field that contains the
field's access flags, name, type, and attributes count.
If there are any field attributes, they are printed too.

TABLE VIII
Extract and print the methods table.

The new_top_level function calls the new_methods_table
function. The new_methods_table function prints the
methods count followed by a line for each method that
contains the method's access flags, name, type, number of
arguments, and attributes count. If there are any method
attributes, they are printed too. Usually, there is a
code attribute for each method. If there is a code
attribute, a line is printed with the max stack, max
locals, and code count. The code attribute can itself
have attributes. There may be exception handlers, source
line numbers, and/or local variables. If they are
there, they are printed after the line for the code
attribute. Then, if the method has byte code, the
instructions are printed in symbolic form.

TABLE IX
Extract and print the class attributes.

The new_top_level function calls the new_top_attributes
function. The new_top_attributes function prints the
attributes count followed by the class attributes. The
most common class attribute is the source file attribute,
which contains the Java source file name.

TABLE X
Print the constant pool.

Finally, the main function calls the print_constant_pool
function. The print_constant_pool function prints the
constant pool entries in a symbolic form, each with its
constant pool index.

TABLE XI
Sample of read_class output.

```
[C:/temp] read_class X
read 243 bytes from X.class
version 45.3
class data okay
constant pool count = 18
constant pool size = 162
constant pool count = 18
constant pool size = 220
access 20 this_class X super_class java/lang/Object
fields_count = 1
0 access 0 name 16 field1 type 10 I count 0
methods_count = 1
0 access 0 name 6 <init> type 5 ( )V args 0 attrs 1
  0 code attr 7 stack 1 locals 1 code count 5
  attributes count 1
  lines_count = 1
  start_pc 0 line_number 1
Method X.<init> ( )V
  0 aload_0
  1 invokespecial #3 java/lang/Object.<init>
  4 return
attributes_count = 1
  0 source file attr 15 X.java
loaded X
num_classes = 1
  1 Class 14 X
  2 Class 17 java/lang/Object
  3 Methodref 2 6 java/lang/Object <init> ( )V
  4 NameAndType 6 5 <init> ( )V
  5 Utf8 ( )V
  6 Utf8 <init>
  7 Utf8 Code
  8 Utf8 ConstantValue
  9 Utf8 Exceptions
10 Utf8 I
11 Utf8 LineNumberTable
12 Utf8 LocalVariables
13 Utf8 SourceFile
14 Utf8 X
15 Utf8 X.java
16 Utf8 fieldl
17 Utf8 java/lang/Object
[C: /temp]
```

PURECOVERAGE is a code-coverage analysis tool for Visual C/C++®, Visual Basic®, Java™, VB.NET, and C# developers. It provides comprehensive testing of applications and fast identification of problem areas throughout the development process. Such is essential to producing high quality software. It helps identify which parts of the application have and have not been exercised in a test run. The IBM Rational® PureCoverage® for Windows tool identifies untested code, so the entire application can be checked for potential problems, not just part of it. Such is marketed by IBM as being able to speed testing efforts, save development time, and enable the creation of more reliable code.

A set of test analysis tools includes a hcJ2MECreateSpec tool 108 that gets the method list. A hcCollectProfile tool 110 collects the results generated by the search engines 102 and 104. A hcFindMethodCountFromProfile tool 112 determines the method count. A hcFindInternal tool 114 analyses the method count to compute the number of evaluated methods, how many methods remain untested, how many of those are untested public methods, and how many are untested internal methods. A hcCreateHtml tool 116 converts the output of hcFindInternal tool 114 into an HTML output format for the user to view.

In general, an object-oriented software system 102 comprises a set of system classes that implement a job. Such system classes operate with each other in an execution environment that provides system classes. Such system classes are themselves in the form of classes that may be called from the system classes for date operations, file operations, etc.

In embodiments of the present invention, each of the particular system classes is tested to the extent that a best balance is obtained between confidence, cost, time, and effort. The extent and order of test may be altered based on the amount of time or money available, etc.

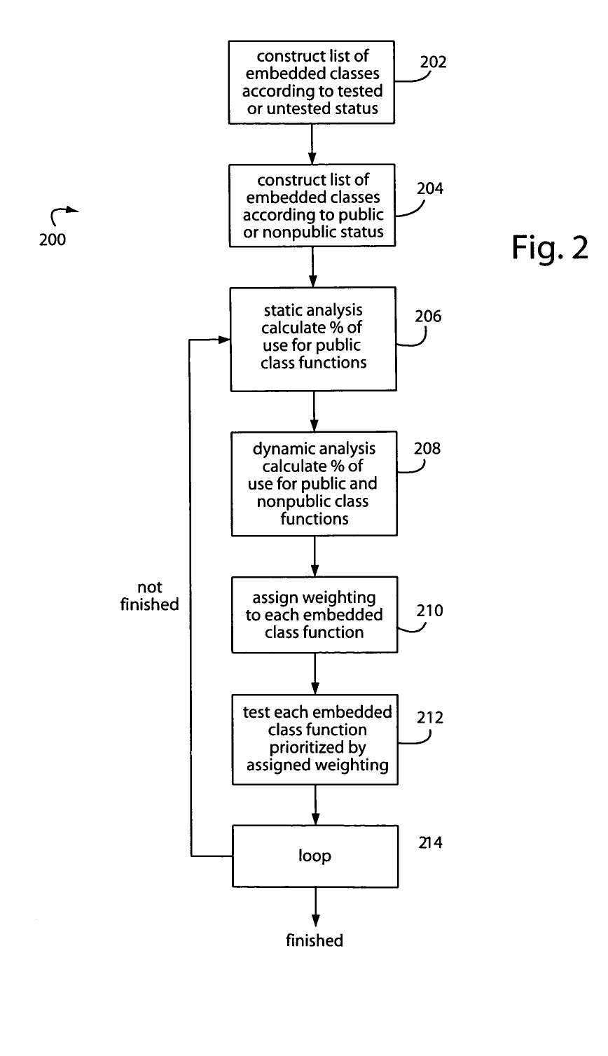

FIG. 2 represents a software testing method embodiment of the present invention, and is referred to herein by the general reference numeral 200. In general, an API specification of system class is used to write a software system, and includes only public classes. A list of system classes and public classes is compiled in a step 202, where a public class is one that could be used by a customer software system. A list of system classes and private classes is compiled in a step 204. A private class is one that may be called internally within the class but cannot be called by a customer program.

A static analysis of the software is done in a step 206. It identifies what system classes are used and how many times each is used. A list is made of the system classes and their functions showing the number of times each system class, or method, is referenced in the system software code, including system classes that are least often referenced. The number of times used is normalized and expressed with a value 0-1.0. Such list of class is then sorted in order of most-used to least-used. One or more static analysis tools can be used in step 206. Only public system classes will be detected. Private system classes will be observed as zero.

A dynamic analysis is done in a step 208. This identifies the extent to which particular system classes are used during system software operation. The test cases used in this analysis can reflect empirical knowledge of system use. The result of the dynamic analysis is a value for the number of times each system class is used. Such value is expressed as a weight in the range of 0-1.0, e.g., for 0-100% usage. A list of system classes is generated and sorted according to their respective weights. Dynamic analysis tools can be used, and both public and private system class calls will be detected.

In a step 210, a weight is assigned for each embedded system class. If the system class is untested, and the observation of static or dynamic use is non-zero, then a weight is assigned, e.g., by adding a constant of four to both the static and dynamic observation percentages. These are expressed as a number in the range of 0-1.0. Such weight will be 4.0≦X≦6.0. A constant of four was used here to demonstrate the process, however other constants can be used such that the weight reflects the priority of test required.

If a system class is untested and public, and the observation percentage of both static and dynamic use are zero, such system class is assigned a weight of four. This signifies it is public, but not currently used.

If a system class is untested and private, it is assigned a weight of three plus the dynamic observation percentage. Such weight will be greater or equal to three and less than four. Private functions are not detected in static analysis. If the system class is public and not fully tested, it is assigned a weight of one plus the static observation percentage plus the dynamic observation percentage. Such weight will be greater or equal to one and less than three.

Any remaining system classes are assigned a weight of zero. Such include private functions that are least often used, and fully tested public functions that are least often used.

Table XII shows the assigned weights according to these steps. The weight will be in the range of 0-7.

TABLE XII

| | Static | Dynamic | |
|---|---|---|---|
| | observation | observation | Assigned |
| Status | percentage | percentage | weight |
| Public, | N => 0 (e.g. | M => 0 (e.g. | 4 + N + M |
| untested | used) | used) | |
| Public, | N = 0 | M = 0 | 4 |
| untested | | | |
| Private, | N = 0 (private | M > 0 | 3 + M |
| untested | functions | | |
| | always have | | |
| | N = 0) | | |
| Public, not | N => 0 | M => 0 | 1 + N + M |
| fully tested | | | |
| Public tested | | | 0 |
| Private | | | 0 |
| tested | | | |
| Private, | N = 0 | M = 0 | 0 |
| untested, | | | |
| unused | | | |
| Private, not | N = 0 | M = 0 | 0 |
| fully tested, | | | |
| unused | | | |

The list of system classes is listed and sorted in order by assigned weight, from greatest weight to least weight. Such steps may be executed sequentially. Software is used to run the static and dynamic test tools, collect the observations, calculate the observation percentage and assign the weights. Alternatively, one or more of these steps may be done manually by a programmer or software engineer.

Testing starts at the highest weighted system class. Testing continues through to some number of system classes in a step 212. The number of functions tested is determined by the amount of time, resources, etc. available to test. The status of the newly tested functions is changed from untested to tested. Clearly, testing would end when all functions are tested, that is, all assigned weights are zero.

Steps 206-212 are repeated by a loop step 214 against the same or different program or customer. Both static and dynamic analysis is repeated, changes to the dynamic use test cases to reflect changes in customer use of the system, weights are assigned to the system classes, the list of functions is sorted and a number of system classes are tested starting with the highest weighted one. Such process is repeated until all system classes are fully tested.

Test cases are created that follow a priority to achieve maximum coverage in order. Classes that are used by existing applications but have not been tested have the highest priority. Classes that are public but not tested have the second highest priority. All the untested private classes have third priority. Highly used public functions that are not fully tested have the fourth priority. Having done this analysis and prioritization, a list of test cases is created that test the methods according to priority. It is then a business decision to run the tests in order to a determined level of priority, until a given amount of time or money is exhausted.

Tools are used in the analysis, and the analysis of the output of these tools provides the method testing priorities. Tools fall into two categories, Static Analysis tools and Dynamic Analysis tools. It is the unique way that the output of these two are combined to give the priorities that gives the present invention its advantages over prior art.

Embodiments of the present invention combine static and dynamic analysis. Weights are assigned to system classes so the first functions tested are the untested and most-used public functions. The last functions tested are least often used. Using this method allows the testing of functions in an optimal order.

Typically, the software produced must satisfy the specifications made a part of the contract between the customer and the software provider. For example, a car manufacturer may ask the software provider to provide a software system comprising a program execution environment and a documented application programming interface (API). The car manufacturer can then use the API provided by the system software to create an application software program that will be run in a front panel of a car, for example. The application software program displays a graphical user interface (GUI) that simulates the meter in the front panel. In the contract the car manufacturer may request that the system software satisfy a specific specification, for example, Sun Corporation's Embedded Java specification (J2ME). The specification describes a set of API's that contains more than 102 Java classes. To fulfill the requirements of the contract, the software provider may invest huge amount of resources to develop all the 102 Java classes and test all the methods of each class to satisfy the contract.

Testing a software product based on its specification is not necessarily the best approach. The software provider may work on something that may rarely be used or not used at all in the customer's product. For example, a car manufacturer's meter GUI would not need all the 102 classes provided, and uses, say only 21 of the 102 classes. Even the importance of each software component (e.g., the classes) used to build the customer's product (e.g., the Meter GUI) varies. For example, it may be the case that only 16 of the 21 classes are used to implement 95% of the Meter GUI and only 13 of the 21 classes are used to implement 90% of the Meter GUI. And in general, it is true that the less a component is used, the harder to implement and test the component. Thus, if by distinguishing the importance of each component, time may be spent developing and testing the components in proportion to the importance of each component.

Such is especially true of software that provides system classes for a number of users. For example, prior art includes systems where a program execution environment is provided for a number of uses, such as the referenced J2ME Java environment. The functions provided in the environment may not be fully used by any one application program running in the environment. For example, the environment provides date functions whether or not a specific system uses dates. Or even if it uses dates it would unlikely use all available date functions. So while the universe of systems running in such an environment would use all the functions provided, a single system may use even a rather small subset of the provided functions. As a new environment is being provided to a number of users, it is desirable to provide the first user robust function fully tested for all functions that are used. While undesirable in the long term, the environment for the first user may include functions that were not fully tested before delivery, if such functions are least often used by the first user. Thus, the environment can be provided to the first users before all functions are thoroughly tested as long as the used functions are tested and operational. Over time, as new users are added who use functions other than those of the first users, it is important to provide fully functional and tested environment functions. Ultimately all environmental functions are tested and the product can be confidently provided to any number of users who are free to use any of the published program interfaces.

In prior art, the process of testing a software product that provides APIs for customers is to a) investigate the specification, b) define test cases based on the complete specification, and c) run the test cases to ensure that the product meets the complete specification. Such way of software test assumes that the developer has enough resource to do the job and the developer does not know who the customers are and the customers will use a product from any unpredictable perspectives. Unfortunately, these assumptions are not always true, resources may be limited. To invest limited resources in testing, fixing bugs to ensure a product meets the complete set of specification will spread the resources so thin that the APIs that are used by the customer may not get enough attention. In the early stage of a new product, the number of customers are limited.

What is needed is a method for testing software that allows for the development and test of the components of a software product, driven by each component's contribution to the success of the customer's target product. One way to measure the importance of a component is how often the component is used in the development of the customer's target product.

Most computer systems have a life beyond the first specification. Computer systems that are successful are modified over time to be responsive to changes in requirements, environment, application, preferences, or to correct errors found after initial test verification. In these cases, the system is changed and tested against the new and changed specifications. Ideally, the software system is verified against the full specification. In large system, the time to re-test the entire system may be prohibitive. It is not unheard of to have a test cycle of several months. And to have an exhaustive re-test of the entire system for each change, while giving the greatest confidence of a correct system, may not be in practice acceptable. Clearly, an efficient test strategy, one that is comprehensive, accurate, and responsive to changes, is desirable and provides a competitive advantage. There are many strategies for testing computer systems. Such include a comprehensive re-test of the entire system at each change to the isolation and re-test of only the changed components of the system. The best test strategy to use is not obvious.

One approach to creating software systems is to implement it using “object-oriented” design and analysis, and programming the system using an object-oriented programming language such as C++, Java, Smalltalk, or others. In such a system, the system comprises “classes” of objects that have attributes and behaviors. For example, a class for an “order” object may have attributes of “date of order”, “date of shipment”, and “invoice total”, and behaviors of “set order date”, “set status as shipped”, and “send invoice to customer”.

In prior art, an object-oriented software system comprises a set of system classes that accomplish the task at hand running in an execution environment that provides several standard useful functions to the software system. Such functions include, for example, date classes for calculating day of the week or number of days between dates or other useful operations. Such systems include “public” functions that provide facilities to the application programmer and are published in the application programming interface (API) document. Such systems also include “private” functions that are used by the system classes themselves, but are neither published nor available to the application programmer. For example, a date class may be provided which offers the public functions of “given a date, return day of the week” and “given a date, return the day of the year”. The interface for using these functions is published in the API document. Within the date class, however, both of these public functions use, say, a utility function “given a date, return a unique integer ‘date number’”. Such is a private function, used by the public functions, but not published and not available to the application programmer. Although private functions are not available to the application programmer, they must be tested if the application program contains calls to any public function which uses the private function.

The testing strategy the classes of the execution environment may take several approaches. First, a thorough test of all execution environment classes can be done. Such approach has the maximum confidence and maximum cost. Another approach is to test only some of the execution environment classes thoroughly, while testing the remaining classes less than comprehensively including not at all. Such approach is less expensive in effort and time at a cost of a decrease in confidence. It is therefore desirable to implement a test strategy that gives the greatest confidence at the least cost.

Conventional systems can provide an automated generation of regression test coverage for a complete computer software system. They do not address the problem of a test strategy other than a complete system or regression test. Nor does it address the best testing strategy an object-oriented system. In practice, it is a business decision to determine the amount of testing done before making the system available. While more and more testing increases the reliability of the system and the confidence that the system provides the specified function, testing must be ended at some point at that the risk of failure is accepted. There are several approaches to determining the test strategy and it is the determination of this point and a characterization or quantification of the risk that is not covered in prior art and is the object of the present invention.

Two ways can be used to compare the classes and methods used in test and application programs. A first approach is to statically count how many times a class is used in the implementation of an application. Such approach is called Static Analysis.

The second approach is to dynamically count how many times a class is activated when running an application, e.g., Dynamic Analysis. Using dynamic analysis alone give some undesirable results. For example, a method may not be activated if the application is a GUI program and the user does not have enough interaction with the program. Or if the application is very complicated, the analysis may be prohibitively expensive in time and effort. Or if the source code of the application is not available, dynamic analysis cannot be done. Finally, to set up a test tool to conduct dynamic analysis can be a complicated process, also expensive in time and effort. Such problems may be resolved by using static analysis. Static analysis, however, cannot find private class usage. As private functions are not published, the application program would not find any reference to any private function. Static analysis also may give an inaccurate estimate of testing required. For example, static analysis can give a count of a single instance of a call to a class, but during processing, this instance may be used repeatedly. Thus static analysis would indicate low importance for the function, while dynamic analysis would indicate a high importance for the function.

An analysis of the customer use of the system can show a different importance to functions and classes than either static or dynamic analysis. That is, the customer may know that one part of a system will be used more than another part. For example, order entry may be used more that product return by more than a factor of 50:1.

A business model embodiment of the present invention for testing software, comprises setting a resource limit on the available time or money that is devoted to testing a particular application software program. The application software program is examined including calls to system classes with both a static analysis tool and a dynamic analysis tool. A static use count of the system classes is determined. A dynamic use count of each of the system classes during operation of the application software program is derived. A proportional weighing attribute to each system class is assigned based on its corresponding static use count and dynamic use count. The system classes are tested in order according to the corresponding proportional weighing attributes, proceeding down to the least heavily weighted system classes. The testing is stopped when the resource limit is reached.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. A method for testing software, comprising:
examining an application software program including calls to system classes with both a static analysis tool and a dynamic analysis tool;
determining a static use count of said system classes;
deriving a dynamic use count of each of said system classes during operation of said application software program;
assigning a proportional weighing attribute to each system class based on its corresponding static use count and dynamic use count; and
testing said system classes in order according to said corresponding proportional weighing attributes.

2. The method of claim 1, wherein:
the step of testing is such that only the most heavily weighted portion of all such system classes are tested at all.

3. The method of claim 1, wherein:
the step of testing is such that only those system classes that are actually used in operation of said application software program are tested at all;
wherein, costs and delays associated with such pointless testing are avoided.

4. The method of claim 1, wherein:
producing a static use count further comprises assigning a static observation percentage to each system class by dividing said static use count by a sum of all static use counts.

5. The method of claim 1, wherein:
producing a dynamic use count further comprises assigning a dynamic observation percentage to each system class by dividing said dynamic use count by a sum of all dynamic use counts.

6. The method of claim 1, wherein:
producing a static use count further comprises assigning a static observation percentage to each system class by dividing the static use count by a sum of all static use counts; and
producing a dynamic use count further comprises assigning a dynamic observation percentage to each system class by dividing the dynamic use count by a sum of all dynamic use counts.

7. The method of claim 6, wherein the a step of assigning to each system class a weight based on the static use count and the dynamic use count further comprises the steps of:
assigning to a public untested system class a first weight defined by a first constant plus a sum of the static use count plus the dynamic use count;
assigning a private untested software class a second weight that is equal to the first constant;
assigning to each public function that is not fully tested a third weight that is defines as a second constant that is less than the first constant, to which is added a sum of the static observation percentage plus the dynamic observation percentage; and
assigning to all remaining public and private functions a fourth weight defined as a third constant that is less than the second constant.

8. The method of claim 1, wherein:
the testing the system classes further comprises ending a test when a testing resource is exhausted and prior to testing a last entry having a least weight.

9. The method of claim 8, wherein:
the testing the system classes further comprises ending a test when at least a limit of available time or funding is exhausted and prior to testing a last entry having a least weight.

10. Software for testing object-oriented system software having system classes, the software having machine readable code for performing the following steps:
running a static analysis tool for examining an application software program and producing a result, the application software program including calls to the system classes;
determining a static use count of the system classes in the application software program from the result;
running a dynamic analysis tool for examining the application software program and producing a dynamic use count based on the application software program's dynamic use of the system functions while running the application software program;
assigning to each system class a weight based on the static use count and the dynamic use count, and testing the system classes, in order, based on the assigned weight, from a first entry having a greatest weight.

11. The software of claim 10, wherein:
producing a static use count further comprises assigning a static observation percentage to each system class by dividing the static use count by a sum of all static use counts.

12. The software of claim 10, wherein:
producing a dynamic use count further comprises assigning a dynamic observation percentage to each system class by dividing the dynamic use count by a sum of all dynamic use counts.

13. The software of claim 10, wherein:
producing a static use count further comprises assigning a static observation percentage to each system class by dividing the static use count by a sum of all static use counts, and
producing a dynamic use count further comprises assigning a dynamic observation percentage to each system class by dividing the dynamic use count by a sum of all dynamic use counts.

14. The software of claim 10, wherein the assigning to each system class a weight based on the static use count and the dynamic use count further comprises the steps of:
assigning to a public untested system class a first weight defined by a first constant plus a sum of the static use count plus the dynamic use count;
assigning a private untested software class a second weight that is equal to the first constant;
assigning to each public function that is not fully tested a third weight that is defines as a second constant that is less than the first constant, to which is added a sum of the static observation percentage plus the dynamic observation percentage; and
assigning to all remaining public and private functions a fourth weight defined as a third constant that is less than the second constant.

15. A software tester, comprising:
means for examining an application software program including calls to system classes with both a static analysis tool and a dynamic analysis tool;
means for determining a static use count of said system classes;
means for deriving a dynamic use count of each of said system classes during operation of said application software program;
means for assigning a proportional weighing attribute to each system class based on its corresponding static use count and dynamic use count; and
means for testing said system classes in order according to said corresponding proportional weighing attributes.

16. The tester of claim 15, wherein:
the means for testing is such that only the most heavily weighted portion of all such system classes are tested at all.

17. A business model for testing software, comprising:
setting a resource limit on the available time or money that is devoted to testing a particular application software program;
examining said application software program including calls to system classes with both a static analysis tool and a dynamic analysis tool;
determining a static use count of said system classes;
deriving a dynamic use count of each of said system classes during operation of said application software program;
assigning a proportional weighing attribute to each system class based on its corresponding static use count and dynamic use count;
testing said system classes in order according to said corresponding proportional weighing attributes and proceeding down to the least heavily weighted system classes; and
stopping testing when said resource limit is reached.
